(19) United States
(12) Patent Application Publication
(10) Pub. No.: US 2008/0120716 A1
(43) Pub. Date: May 22, 2008

(54) System and method for enhancing security of an electronic device

(76) Inventors: David N. Hall, Rancho Santa Margarita, CA (US); Charles Lee, Ladera Ranch, CA (US); Sheryl A. Sedenstrom Coggins, Norco, CA (US); Mayumi Maeda, Tokyo (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/821,243

(22) Filed: Jun. 22, 2007

Related U.S. Application Data
(60) Provisional application No. 60/860,524, filed on Nov. 21, 2006.

(51) Int. Cl. G06F 21/00; G06F 12/14; H04L 9/32

(52) U.S. Cl. 726/16; 726/28; 726/36

(57) ABSTRACT

According to one embodiment of the invention, a method comprises detecting an event that suggests unauthorized access to a subscriber device. After such detection, an activity or series of activities are performed in response to detecting the event in order to place the electronic device into a secured operating state.

### CROSS-REFERENCE TO RELATED PATENTS

This application is based on and claims the benefit of priority on U.S. Provisional Application No. 60/860,524 filed Nov. 21, 2006, the entire contents of which are incorporated herein by reference.

### FIELD

Embodiments of the invention generally relate to a system, software and method for enhancing security of an electronic device by controlling components within the device in order to protect stored data and/or hinder unauthorized usage of the device. These operational controls are in response to a detected local or remote event.

### GENERAL BACKGROUND

Over the past decade, tremendous advances have been made in wireless communications, and thus, there has been an increased demand for wireless electronic devices. One reason for this increased demand is that wireless electronic devices are portable, which enables consumers to use the device in transit or when remotely located from one's home or office. Cellular telephones, laptop computers and personal digital assistants (PDAs) are just some of the wireless electronic devices used daily by millions of people.

Due to their portability, however, wireless electronic devices are easily misplaced, lost or stolen. In fact, billions of dollars worth of cellular phones and laptop computers are stolen every year. While these replacement costs may surprise some people, they do not take into account ancillary costs such as data re-entry and reconfiguration costs or any future costs that may result from the loss and/or exposure of sensitive or proprietary information stored within these devices.

It is recognized that some consumers have made efforts to protect data stored within their electronic wireless devices. Despite the development of new technologies, however, passwords are still the most common security tools for preventing access to stored data by unauthorized persons. Even though a substantial percentage of customers do not use password security tools at all, even when used, password security tools offer no useful protection against unauthorized access of stored data if the wireless electronic device is fully operational when stolen, lost or even left unattended.

### BRIEF DESCRIPTION OF THE DRAWINGS

Features and advantages of embodiments of the invention will become apparent from the following detailed description in which:

FIG. 1 is an exemplary embodiment of a network utilizing an embodiment of the invention.

FIG. 2A is an exemplary embodiment of a block diagram of the internal architecture of the first device of FIG. 1 implemented with a security component.

1FIG. 2B is an exemplary embodiment of a block diagram of the external architecture of the first device of FIG. 1 implemented with a security component.

FIG. 3 is an illustrative embodiment of certain components forming the security subnet.

FIG. 4 is an illustrative embodiment of the subscription process for enhanced Auto-Lock security.

FIGS. 5A-5D are illustrative embodiments of screen shots for different stages of the subscription process and Auto-Lock configuration.

FIG. 6 is an illustrative embodiment of the flow chart describing the operations of the security component.

FIG. 7 is an illustrative embodiment of the operations of the subscriber device and its optional interaction with the backend server.

FIG. 8 is an illustrative embodiment of the operations of a subscriber device operating in the S0-state and its interactions with the backend server.

FIG. 9 is an illustrative embodiment of the operations of a subscriber device operating in a power-saving state (S3-S5) and its interactions with the backend server.

### DETAILED DESCRIPTION

Embodiments of the invention set forth in the following detailed description generally relate to a system, software and method for enhancing security of an electronic device by its placement into an “Auto-Lock” state. The electronic device is implemented with a security component that places the device into the Auto-Lock state in response to local events. In addition, the electronic device may be placed into the Auto-Lock state in response to signaling from an external source (i.e., a remote event). Local and remote events may be reference generically as an “event” or a “triggering event”.

According to one embodiment of the invention, the electronic device enters into the Auto-Lock state by actively logging off the current user (when the electronic device is in use) and disabling normal access to information stored within the electronic device. Such access may be returned once the user has been authenticated or the event that caused the electronic device to enter into the Auto-Lock state has been undone.

As an illustrative embodiment of the invention, the electronic device may be placed into the Auto-Lock state by (i) logging off the current user if necessary, (ii) disabling all user accounts (e.g., Windows® accounts), and (iii) activating a secure account that is enabled to require some action to occur before the user accounts are restored. This action may involve user authentication and/or establishment of a network connection to a specified server. While the secure account is active, access to system configurations and/or components of the electronic device may be precluded. Examples of access preclusion include, but are not limited or restricted to Basic Input/Output System “BIOS” password setting, hard disk drive “HDD” password setting, or disablement of input devices (e.g., mouse, keyboard, Universal Serial Bus “USB” port or a USB drive AutoPlay® feature), a full system shutdown after setting passwords, or the like.

Of course, other activities inclusive or exclusive of access preclusion may be performed upon placement of the electronic device into the Auto-Lock state. Examples of these activities include, but are not limited or restricted to one or more of the following: message display, file deletion, global positioning system “GPS” activation, keystroke logging, restricting the BIOS Boot Priority, and the like.

In the following description, certain terminology is used to describe various features of one or more embodiments of the invention. For instance, a “subscriber device” is generally defined as any electronic device that is capable of establishing communications with a resource in order to upload or download information from that resource. Examples of subscriber devices include, but are not limited or restricted to any computer (e.g., laptop, tablet, handheld, desktop, etc.), an electronic organizer, a personal digital assistant, a cellular telephone, an alphanumeric pager, a portable music player, a video or video game player, and the like.

A “component” is generally defined as one or more instructions that, when executed, cause the subscriber device to perform a particular function or functions. These instructions may be stored within machine-readable medium such as firmware or software. Of course, the term “component” may be expanded to include hardware. “Machine-readable medium” is any medium that can at least temporarily store information including, but not limited or restricted to the following: an electronic circuit, a semiconductor memory device (non-volatile or volatile), a hard disk drive, and various types of portable storage devices (e.g., flash drive, compact disc “CD”, digital versatile disk “DVD”, etc.).

In general, a “local event” is an activity that suggests current usage of the subscriber device may be unauthorized. The activity may involve suspicious operations being performed on software and/or hardware of the subscriber device or may involve operations prevented from being performed by the subscriber device, such as hindering communications with a security subnet. As illustrative examples, placement of a kill-switch into an OFF position to immediately disconnect wireless communications constitutes a local event; attempted deletion of certain applications or files constitutes a local event; attempted resetting of normally static system configuration files constitutes a local event; and non-receipt of signaling from a remote source constitutes a local event.

A “remote event” is an action by the subscriber or an agent of the subscriber that requests placement of the subscriber device into the Auto-Lock state. Such placement may be in response to a lack of physical access to the subscriber device, which may have been caused by theft, loss or misplacement.

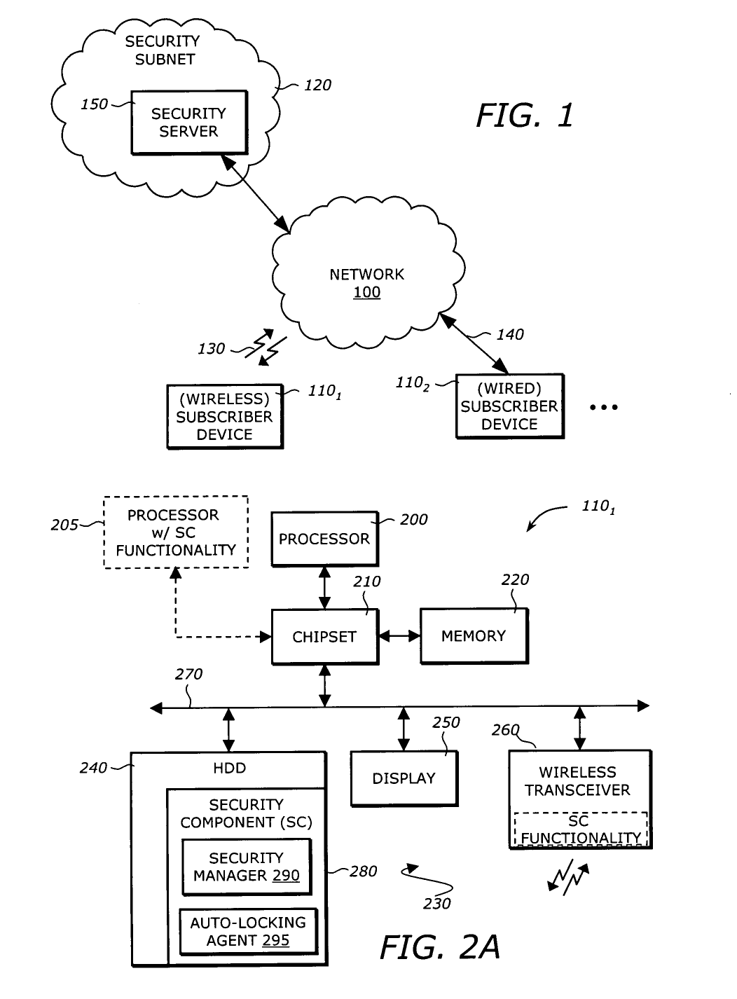

Referring to FIG. 1, an illustrative embodiment of a network utilizing the invention is shown. According to one embodiment of the invention, network 100 is a public network that provides connectivity between a plurality of subscriber devices 110₁-110_{N} (N≧1) and a security subnet 120. Examples of a “public network” include a wide area network such as the Internet and/or a carrier's cellular network. Of course, it is contemplated that network 100 may be a private network (e.g., local area network), or a combination of private and public networks.

As shown, according to one embodiment of the invention, a subscriber device 110₁ is a wireless electronic device that is capable of establishing wireless communications with network 100 through a wireless interconnect 130. The wireless communications, which involve an exchange of wireless signals such as RF or cellular signals for example, enable subscriber device 110₁ to communicate with other devices that are coupled to network 100. For instance, subscriber device 110₁ may be in communication with another subscriber device 110₂ that is coupled to network 100 over a wired interconnect 140.

In addition, as shown in FIG. 1, subscriber device 110₁ is in communication with a security subnet 120 that includes a security server 150. According to one embodiment of the invention, security server 150 operates as a back-end server for a subscription service that is provided to enhance device security by downloading security software or activating a preloaded security component that is responsible for determining and placing subscriber device 110₁ into the Auto-Lock state as needed.

This subscription service also features a unique scheme for prompting subscriber device 110₁ to establish connectivity over network 100 even when subscriber device 110₁ is in an Advanced Configuration and Power Interface sleep state (e.g., S3-S5 states). Such connectivity enables server 150 to download one or more instructions that are configured to control the placement of subscriber device 110₁ into the Auto-Lock state.

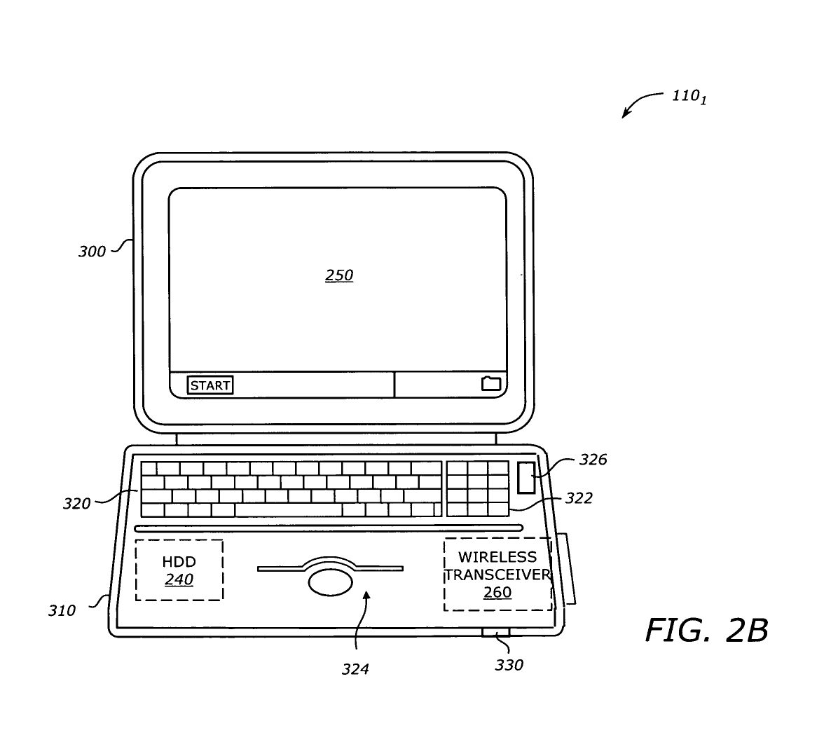

Referring now to FIG. 2A, an exemplary embodiment of internal architecture of subscriber device 110₁ of FIG. 1 implementing a security component to enhance security is shown. Subscriber device 110₁ comprises a processor 200 coupled to a chipset 210. Chipset 210 controls the flow of information between processor 200, a main memory 220 and a plurality of input/output (I/O) devices 230 each coupled to an internal bus 270. According to one embodiment of the invention, the plurality of I/O devices 230 include, but are not limited or restricted to a hard disk drive (HDD) 240, a display 250, and a wireless transceiver 260.

As shown, hard disk drive 240 is configured to include a security component 280, which comprises a security manager 290 and an auto-locking agent 295. According to one embodiment of the invention, security component 280 is a series of instructions for responding to a local event by placing subscriber device 110₁ into the Auto-Lock state. These instructions may be hard-coded instructions, namely code instructions that are stored in persistent storage and may or may not be alterable. According to another embodiment of the invention, security component 280 is software that is either preloaded on hard disk drive 240 or loaded from a separate source (e.g., downloaded from server 150 of FIG. 1, uploaded from a portable storage device such as a compact disc, digital versatile disk, flash drive, flash memory, etc.).

According to one embodiment of the invention, the Operating System (OS) implemented within first device 110₁ has a set of Application Programming Interfaces (APIs) that allow applications to interact with the OS, components and remote entities. These APIs are made available to security component 280 in the form of a software development kit that includes API source and program code. Security component 280 uses the APIs to create its components, such as security manager 290 and auto-locking agent 295, and to install and configure these components for running on subscriber device 110₁.

Referring still to FIG. 2A, according to one embodiment of the invention, security manager 290 is configured to detect local events, namely activities that are suspicious and suggest unauthorized access to subscriber device 110₁ (e.g., wireless or wired electronic device). These local events may involve activities being performed on subscriber device 110₁ or activities that are prevented from being performed by subscriber device 110₁.

As described above, activation of a kill-switch that disables communications via wireless transceiver 260 would constitute a local event. Another illustrative example of a local event is the attempted deletion or modification of security component 280 that is installed on subscriber device 110₁. Yet another example of a local event is when an expected operation cannot be performed, due perhaps to the stopping of certain OS programs.

According to one embodiment of the invention, it is contemplated that an event may be, in context of operation of the OS and security component 280, the collective use of a synchronizing object. For instance, a typical multitasking operating system kernel has “synchronizing objects” to allow tasks (code execution) to coordinate or communicate with one another.

One type of synchronizing object is referred to as an “event object,” which can exist in a “cleared” or “set” state. The state is associated with a particular condition of interest. Placement of the event object into a “set” state generally indicates that the condition has been satisfied. A reset, putting the event object back to cleared state, is done so the condition may be checked again.

In the detection of a local event caused by activation of kill-switch 330 of FIG. 2B for example, security manager 290 requests the OS to create an event object corresponding to that local event, which will be placed in the cleared state initially. Auto-locking agent 295 would place subscriber device 110₁ into Auto-Lock state upon a “set,” which is done by security manager 290 when it finds kill-switch is activated. After that, the subscriber device 110₁ may be placed into a normal operating state, with perhaps additional network connectivity to the security subnet required.

In the detection of attempted deletion of files of the security component, security manager 290 would have already requested the OS to provide an event object associated with conditions of the files. Auto-locking agent 295 would wait for a “set” to occur. In this case, the transition to set state is done by the OS.

According to another embodiment of the invention, as an optional feature, security manager 290 may be adapted to detect a remote event that identifies potential unauthorized access to first device 110₁. This remote event may be in the form of the subscriber or an agent for the subscriber (e.g., enterprise information technology “IT” personnel) requesting that subscriber device 110₁ be placed into the Auto-Lock state, especially when the subscriber has lost physical control of subscriber device 110₁.

Auto-locking agent 295 is responsible for disabling access, disabling components, displaying messages, or performing any other activity or series of activities associated with placing subscriber device 110₁ into the Auto-Lock state. For instance, according to one embodiment of the invention, the setting of the BIOS or HDD password effectively disables the BIOS and hard disk drive until the correct password is entered. Moreover, the deletion of files, locking the current account, logging off the current account, account disablement, and forced shut-down constitute more intrusive disablement techniques. The other activities may include initiation of an audible alarm, keystroke logging, encryption of various stored files, activation of GPS logic or a camera mounted on subscriber device 110₁, or the like.

As represented by dashed lines, in lieu of and in addition to being stored within hard disk drive 240, security component 280 may be implemented within wireless transceiver 260 or as a co-processor 205.

Referring now to FIG. 2B, an exemplary embodiment of a block diagram of the external architecture of first device 110₁ of FIG. 1 is shown. First device 110₁ includes a display 300 and a main body 310. Display 300 is a casing surrounding a flat panel display 250 such as a liquid crystal display, for example.

As further shown, main body 310 operates as a housing for components 200, 210, 220, 240 and 260 shown in FIG. 2A in order to protect these components from adverse environmental conditions. However, one or more input devices are positioned along an exterior surface of main body 310 and are accessible to the user. The input devices include one or more of the following: a keyboard 320, a keypad 322, a touchpad 324, a biometric authentication device 326, or the like.

Additionally, a kill-switch 330 is implemented on main body 310. When placed into an OFF position, kill-switch 330 disables wireless connectivity with first device 110₁ by deactivating wireless transceiver 260.

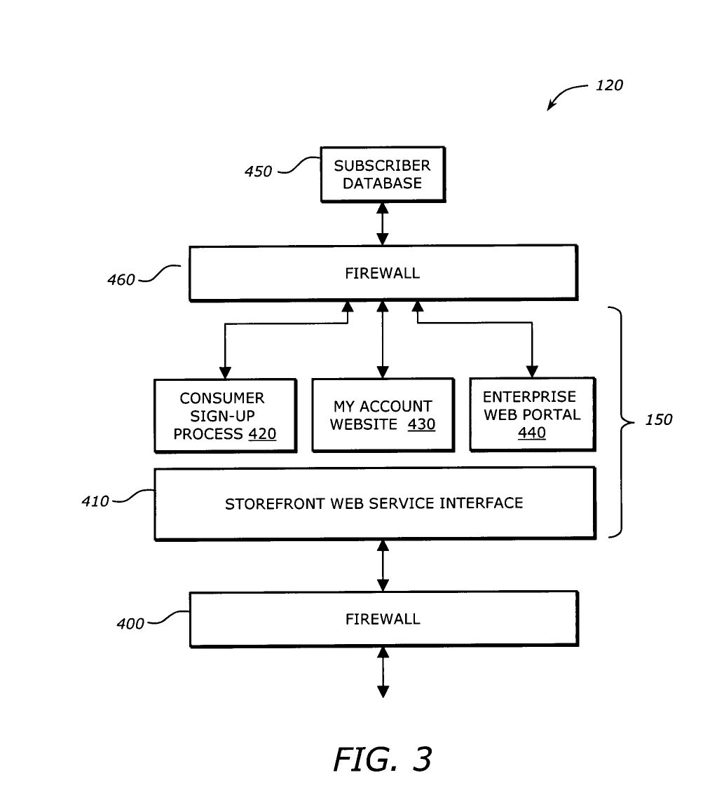

Referring now to FIG. 3, an illustrative embodiment of certain components forming security subnet 120 is shown. Security subnet 120 is adapted to allow user to access a storefront web service interface 410 via a firewall 400 over a secure link (e.g., HTTPS connection). The storefront web service interface 410 provides the marketing verbiage that communicates the nature of the security service and encourages customers to sign up for a subscription to the security service. Storefront web service interface 410 further includes individual or customer sign-up processes 420, “My Account” website 430 and an enterprise web portal 440.

Consumer sign-up process 420 is a process that allows consumers to create subscription accounts for enhancing security of first device 110₁ as described below.

My Account website 430 allows each subscriber to sign in, manage his/her account and submit instructions for security manager 290 of FIG. 2B. My Account website 430 presents a listing of scenarios that identify the current status of each subscriber device. As described below, the listing includes an “Auto-Lock” scenario that, when selected, causes signaling to be transmitted to the subscriber device. Such signaling is adapted to (i) disable components of the subscriber device, (ii) display messages, and/or (iii) perform any other activity or series of activities designed to locate or preclude unauthorized access to stored data. The signaling may be in the form of instructions preset by the software vendor or configured by the subscriber as described below.

The enterprise web portal 440 provides access for enterprise administrators to add/remove subscribers and to activate or deactivate first device 110₁ from the Auto-Lock state. Each enterprise administrator will automatically receive emails with his or her account information and uniform resource locator (URL) to the enterprise web portal 440. Enterprise web portal 440 then gives these administrators full control of the security services for their users. Of course, it is contemplated that the enterprise administrator may be informed of status changes other than by email (e.g., phone, in-person dialogue, text message, etc.) to prompt administrator to act accordingly.

Herein, the consumer sign-up process 420, My Account website 430 and enterprise web portal 440, are in communication with a subscriber database 450 via a firewall 460. Firewall 460 provides a secure communication path between the processes associated with storefront web service interface 410 and data stored in the subscriber database 450. The data stored within subscriber database 450 includes the particular instructions for each of the scenarios for each subscriber device when the instructions are selectable by the subscriber. However, if the instructions are static for each scenario and are not configurable by the subscriber, subscriber database 450 would need to merely store a common series of instructions for each scenario (not subscriber dependent). Besides subscriber database 450, it is possible that such instructions may be stored in Web Service Interface 410 or even in Auto-locking agent 295 of FIG. 2A.

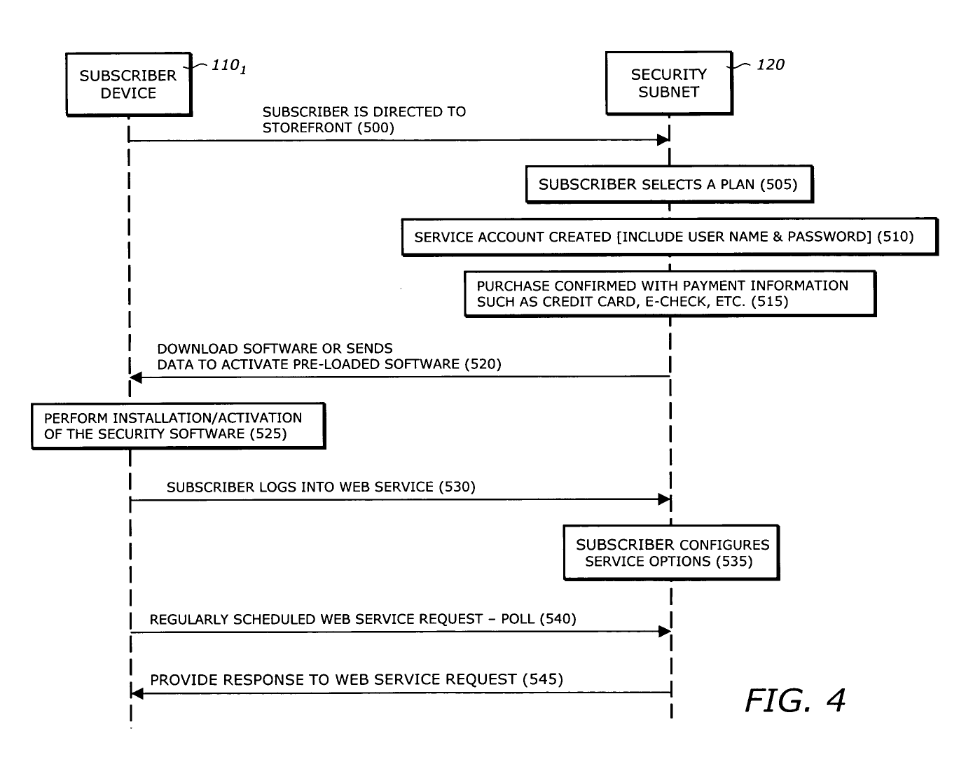

Referring now to FIG. 4, an illustrative embodiment of an exemplary embodiment of the subscription process for Auto-Lock security is described. Initially, a subscriber device 110₁ initiates communications with security subnet 120 as represented by operation 500. Such communications may be established by subscriber accessing the storefront web service interface of security subnet 120.

Upon establishing communications with security subnet 120, the subscriber selects a subscription plan that includes an auto-lock mechanism, namely a theft protection mechanism that monitors operations of subscriber device 110₁ in order to detect local or perhaps remote events (operation 505). As an optional feature, the auto-lock mechanism is adapted to detect signaling from a remote source that may cause subscriber device 110₁ to enter into the Auto-Lock state.

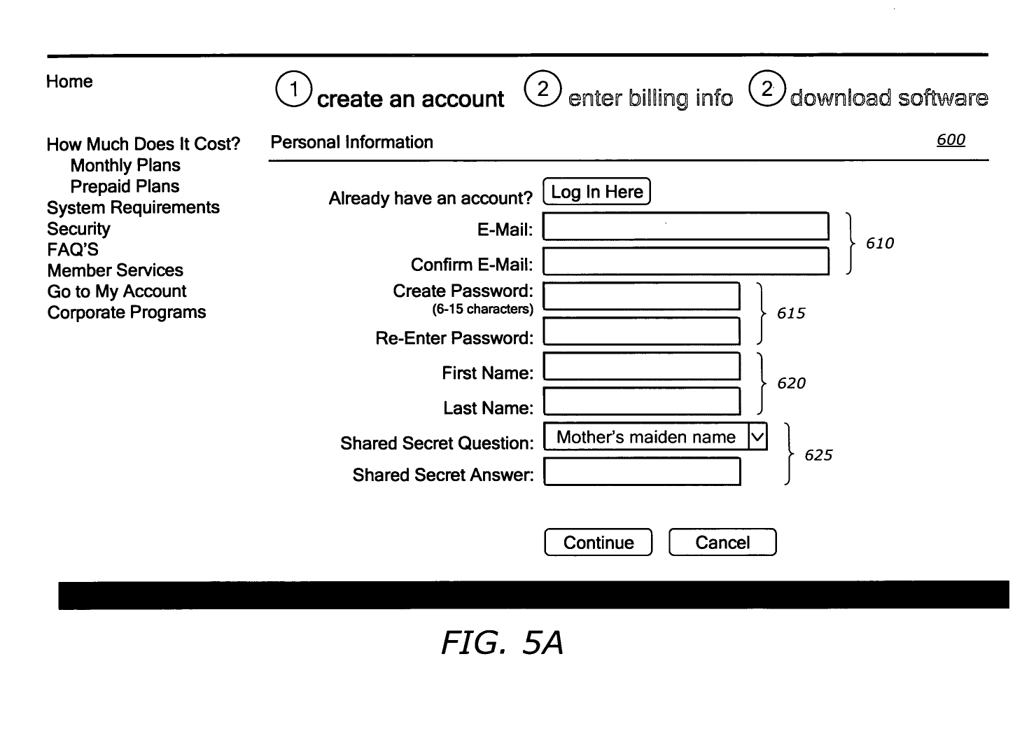

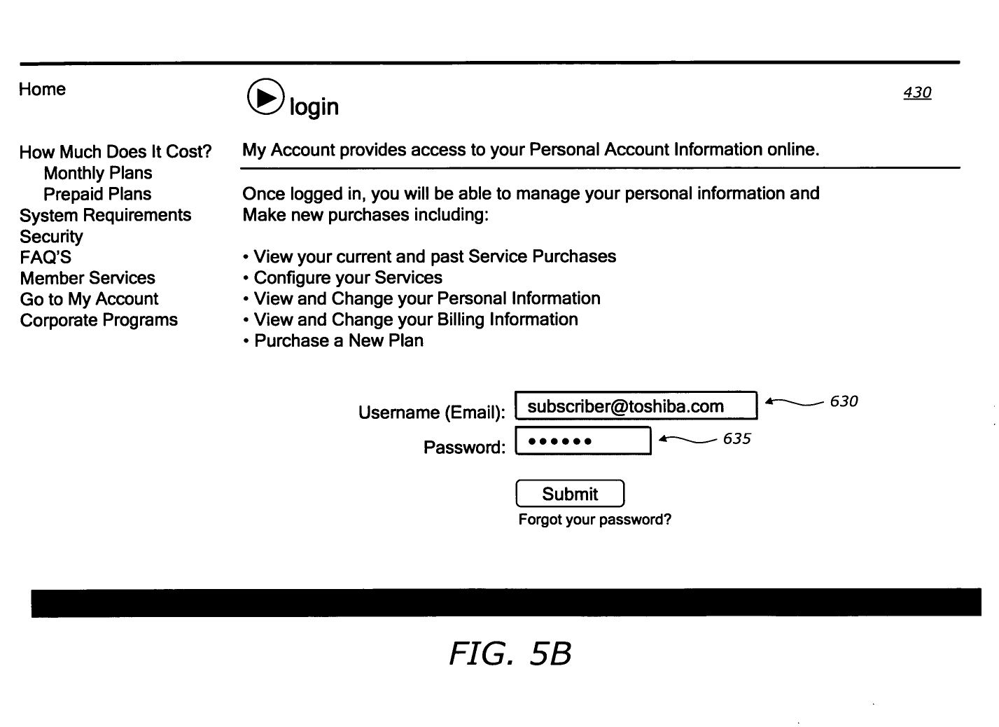

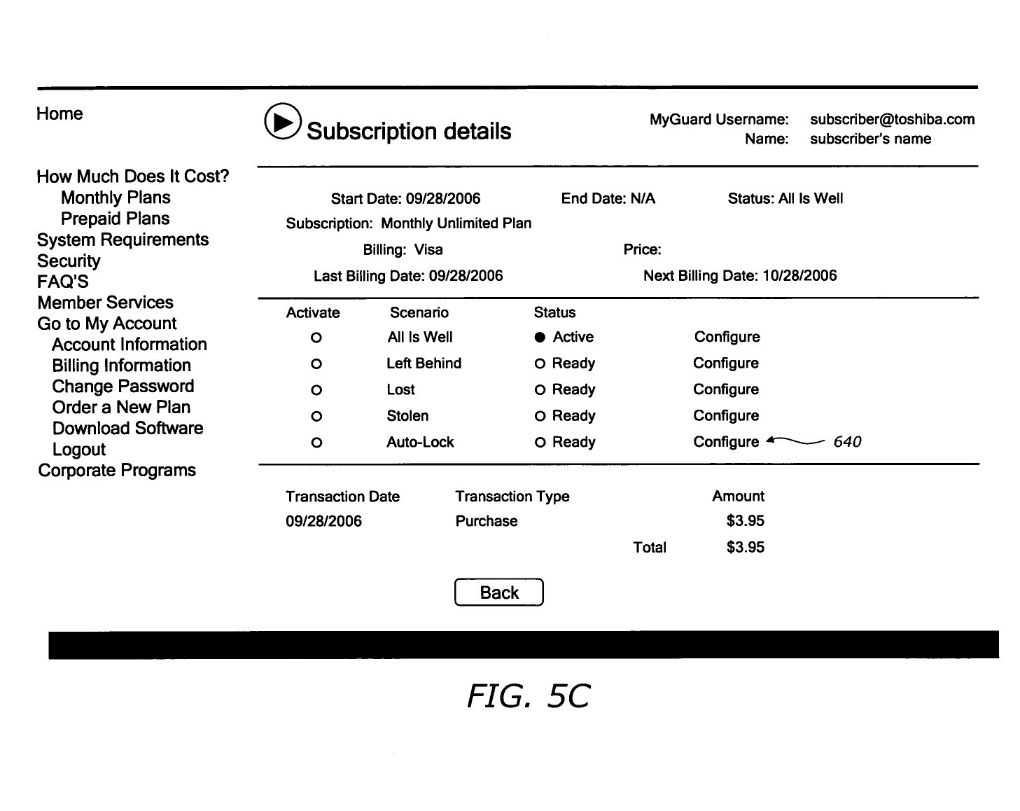

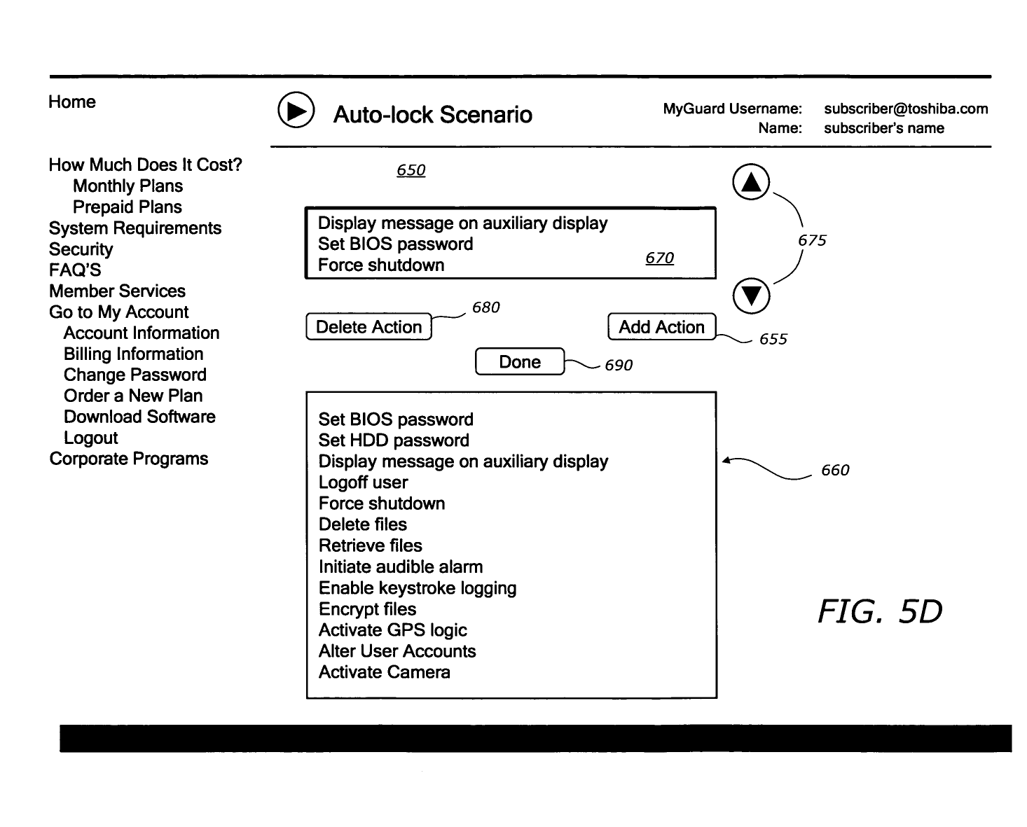

Before or after selecting the subscription plan, a service account is created in which a username and password are established for the user (operation 510). As shown in FIG. 5A, according to one embodiment of the invention, the service account may be created based on information input into a subscription enrollment window 600.

For instance, as an illustrative example, the information input by the subscriber may include an electronic mail (email) address 610, a password 615 selected for accessing the service account, the first and last name of the subscriber 620, and a shared secret question and answer 625 for subscriber authentication and password resetting if that the subscriber forgets his or her password.

Referring back to FIG. 4, the service account is completed and generated after confirmation that payment is received such as confirmation through credit card, an electronic check (e-check) or other electronic banking mechanism (operation 515).

After the service account is established, security subnet 120 downloads software, such as a set-up program, to subscriber device 110₁ for installation of the security component (operation 520). Of course, it is contemplated that software may not be downloaded, but rather, data may be transmitted from security subnet 120 to subscriber device 110₁ in order to activate pre-loaded software and/or firmware within subscriber device 110₁.

In response to receipt of a download of software or data to activate the pre-loaded software and/or firmware, installation and activation operations are performed (operations 525). According to one embodiment of the invention, this is accomplished by subscriber device 110₁ running an activation wizard. This wizard will prompt for the subscriber's current username and password, and thereafter, will securely send this information to the subscriber database of FIG. 3 along with optional information (e.g., ESN, phone number, computer name, model name, serial number, etc.) for identifying subscriber device 110₁ to the subscriber and to security subnet 120. In response to subscriber database 450 receiving this information, a Globally Unique Identifier (GUID) will be sent to subscriber device 110₁ to be used in future communications with subscriber device 110₁ to security subnet 120. The wizard can be pre-installed on all subscriber devices to help advertise the security subscription services.

After installation and in order to configure service options, the subscriber logs into the “My Account” website 430 as shown in FIG. 5B (operation 530). The subscriber log-in may be accomplished by providing his or her username 630, such as the subscriber's email address, and a password 635 that was selected during creation of the service account as described in FIG. 5A.

After logging into the storefront web service interface, the subscriber may configure options for the service account (operation 535). According to one embodiment of the invention, as shown in FIG. 5C, the configuration would involve selection of a “Configure” element 640 that corresponds to the condition the subscriber device 110₁ would be placed into by the Auto-Lock agent 295 of FIG. 2A when Security Manager 290 of FIG. 2A detects a local event.

In particular, upon selecting “Configure” element 640, an “Auto-Lock” programming page 650 is displayed as shown in FIG. 5D. Auto-Lock programming page 650 allows one or more actions to be selected and ordered that, upon completion, the security subnet transmits instructions associated with the actions to subscriber device 110₁. These instructions are carried out by the auto-locking agent in order to disable access to certain components, display messages, delete files or the like when the security manager detects a local or remote event.

More specifically, upon selection of the “Add Action” button 655, a complete list of actions is provided in a pop-up window 660. Pop-up window 660 includes a list of all possible actions that are performed by the subscriber device when placed into the Auto-Lock state. According to one embodiment, the list includes some or all the following actions: (1) set BIOS password; (2) set HDD password; (3) display a message on an auxiliary display; (4) log off user; (5) force shutdown; (6) delete files; (7) retrieve files perhaps through enablement of terminal services; (8) initiate audible alarm; (9) enable keystroke logging; (10) encrypt files; (11) activate GPS logic; (12) alter user accounts; and (13) activate a camera for control transmission of a video feed or still pictures.

Upon the subscriber selecting one or more of these actions, pop-up window 660 disappears and the selected action are now listed in an instruction window 670. Instruction window 670 identifies the actions that will be performed based on instructions that will be transmitted upon completion of Auto-Lock programming page 650 or when the subscriber wishes to place the subscriber device into an Auto-Lock state remotely. These actions can be reordered by use of scroll buttons 675 to move a selected item in instruction window 670 to precede or follow another action. This may be used to selectively program the order in which actions are performed by the subscriber device when entering into the Auto-Lock state.

In order to delete actions listed in instruction window 670, the action is first selected and then a “Delete Action” button 680 is selected. This will remove the selected action from instruction window 670. Upon completion, a “Done” button 690 may be selected to exit Auto-Lock programming page 650.

Referring back to FIG. 4, as an optional feature, after the subscriber has configured the service options, subscriber device 110₁ is scheduled to transmit polling requests to the security subnet. The exchange of polling requests and responses is optionally designed to ensure security subnet 120 and its users that subscriber device 110₁ is still functional, within reach, and working correctly, even when subscriber device 110₁ is in S3-S5 states (operations 540 and 545).

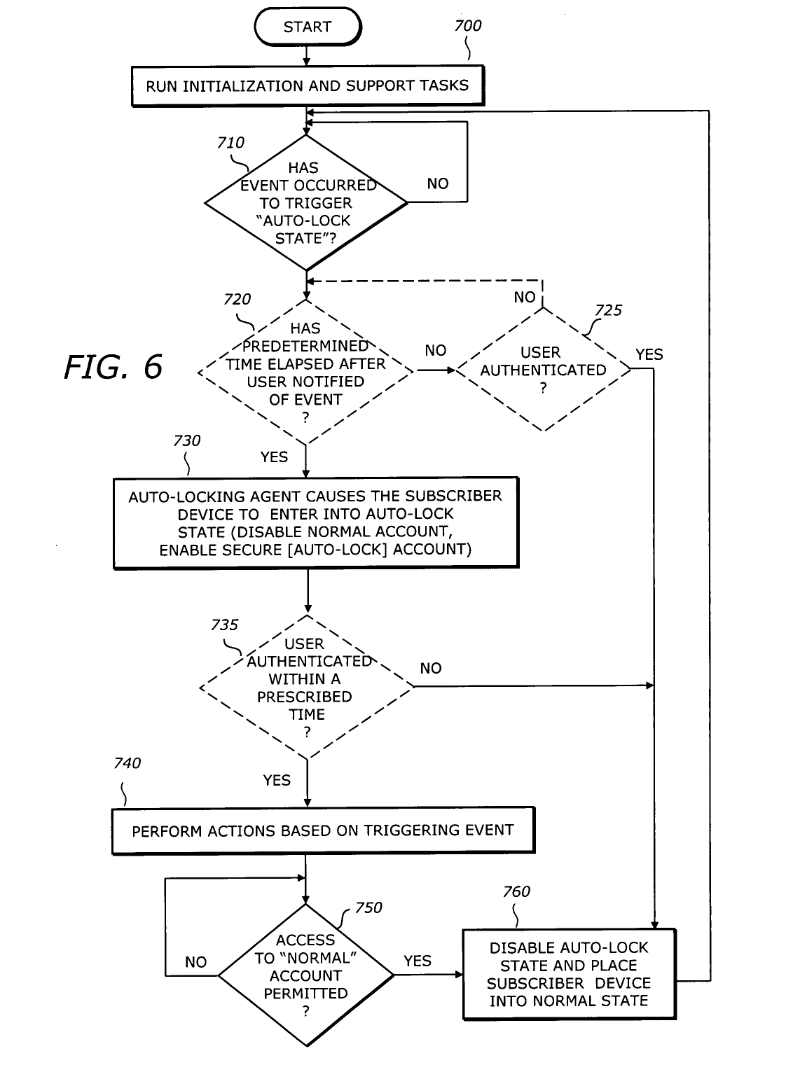

Referring now to FIG. 6, an illustrative embodiment of the flow chart describing the operations of the security component, namely security manager 290 and auto-locking agent 295 of FIG. 2A, is shown. Herein, the initialization process and support tasks are run in order to set up the security manager and the auto-locking agent (block 700). Next, as shown in block 710, a determination is made whether an event (local or remote) has occurred to cause subscriber device 110₁ of FIG. 1 to enter into the Auto-Lock state.

According to one embodiment of the invention, this determination may be accomplished by a number of mechanisms. For instance, the security manager may register with the OS file-system to receive change events or poll the OS for system changes. As another example, the security manager may create a notification channel to receive events or commands from programs and hardware directly. As yet another example, the security manager may use the APIs to query hardware states. Optionally, if supporting remote placement of the subscriber device into the Auto-Lock state, the security manager may detect certain events (triggering events) from a remote source or receive signal from another component that detected or received instructions from the remote source. For instance, referring to FIG. 5C, a consumer may choose to activate the “Auto-Lock” scenario by clicking the “Auto-Lock” radio button under the Activate column and confirming that this scenario change event should be communicated to subscriber device 110₁.

If no events have occurred to cause the subscriber device to enter into the Auto-Lock state, the security component waits a predetermined period of time or waits indefinitely until another triggering event has occurred. When configured to wait for a predetermined period of time, the security component may perform security checks at particular intervals, including checks on whether certain triggers for corresponding triggering events are active or inactive. When the Auto-Lock state is to be entered, as an optional feature shown in blocks 720 and 725, the user is provided with a predetermined amount of time to authenticate himself or herself before placing the subscriber device into the Auto-Lock state (e.g., disabling the normal account(s) and enabling the secure account associated with Auto-Lock).

Hence, the security component would commence a timing cycle and halt the timing cycle if the user is authenticated. For instance, according to one embodiment of the invention, the security component provides a user authentication mechanism such as a user interface (e.g., dialog box) that prompts the user to enter his or her credentials (e.g., password, employee number, etc.). Another user authentication mechanism may involve activation of Bluetooth® transceiver logic and confirmation that a Bluetooth® compatible device owned by the user or registered with the security component is in the immediate vicinity of the subscriber device.

If the subscriber is authenticated, the process returns to wait for another triggering event. If the subscriber was notified of the event but failed to authenticate himself or herself, the auto-locking agent causes the subscriber device to enter into the Auto-Lock state by logging off any currently logged-in users, disabling the normal account(s) and enabling a secure auto-lock account during the Auto-Lock state (block 730).

After the auto-locking account has been activated and the normal accounts have been disabled, as an optional feature shown in block 735, the user is provided with a prescribed amount of time to authenticate himself or herself based on the subscriber service username and password before performing actions based on the triggering event. If the subscriber failed to authenticate himself or herself, certain actions are performed based on the triggering event (block 740). After these actions have been performed, the security manager monitors the current state of the subscriber device and determines whether access to the normal account is permitted (block 750). This may involve user authentication or detection that the triggering event has been undone or reversed, if possible.

As an example of the triggering event being undone, if the triggering event is the wireless kill-switch 330 being turned off, the user can turn this switch back on, thus reversing the triggering event. In the former case, and whenever user authentication is requested, user authentication may occur via entry of passwords, biometric authentication, Bluetooth® device authentication, or a notification to the backend server that the subscriber has possession of the subscriber device or the like.

In the event that the triggering event is undone, according to one embodiment of the invention, permission to access “normal” accounts 750 may be further delayed until the security subnet 120 of FIG. 1 authorizes access. For example, referring to FIG. 5C, the security subnet may reject authorization if the subscriber requested activation for any scenario other than “All is Well”.

When access to the normal account(s) is permitted, the secure auto-lock account is disabled and the normal account(s) is enabled (block 760).

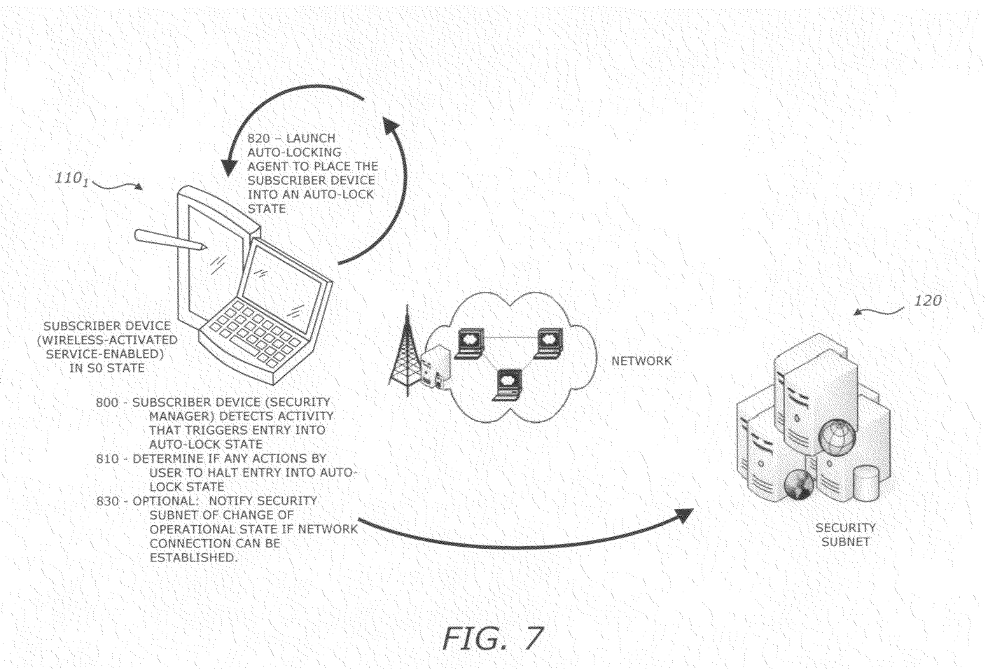

Referring now to FIG. 7, an illustrative embodiment of the operations of subscriber device 110₁ and optional interactions with the backend server 150 implemented within security subnet 120 is shown. Subscriber device 110₁ is placed in an operational (S0) state and detects a local event. In other words, the security manager detects suspicious activity that triggers (signals) subscriber device 110₁ to enter into the Auto-Lock state (800).

Before placing subscriber device 110₁ into the Auto-Lock state, as an optional feature, a determination is made whether the user has authenticated himself or herself within a selected time period. If so, the security manager will not launch the auto-locking agent in order to halt entry of subscriber device 110₁ into the Auto-Lock state (810). If the user has not been authenticated, the auto-locking agent is launched (820). According to one embodiment of then invention, the auto-locking agent disables one or more current accounts, enables the secure auto-lock account, and performs operations on components within subscriber device 110₁ based on the type of local event detected.

As an illustrative example, in the event that a kill-switch of subscriber device 110₁ is moved from an ON position to the OFF position and the OS is running, this activity constitutes a local event. As a result, according to one embodiment of the invention, the display screen is locked and the HDD password is set, if it is not already set. The lock will remain in effect until the user is authenticated or the activity has been corrected (undone or reversed). Where auto-lock is a feature of the subscription security service described above, the lock may remain in effect until either (1) the username and password for the subscription service is entered or (2) the kill-switch is moved to an ON position and the backend server indicates that subscriber device 110₁ is in possession of the subscriber.

As an optional feature, after launching the auto-locking agent to place subscriber device 110₁ into an auto-lock state, notification of the change of operational state may be provided to security subnet 120. This will notify the back-end server of subscriber device 110₁ is in the Auto-Lock state.

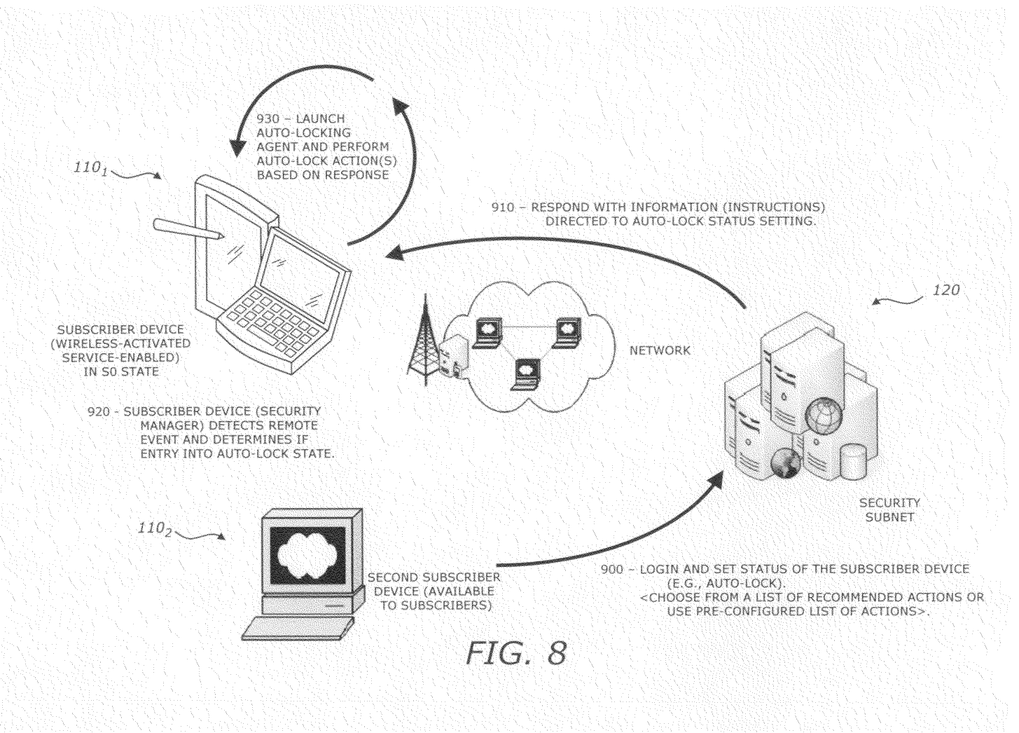

Referring to FIG. 8, an illustrative embodiment of the operations of subscriber device 110₁ and interactions with backend server 150, implemented within security subnet 120 of the subscription services network of FIG. 1, is shown. Subscriber device 110₁ is in a fully operational state (S0) and is remotely located from the subscriber due to theft for example.

As shown, the subscriber establishes a network connection using another subscriber device 1102 with security subnet 120 and, since subscriber device 110₁ has been stolen, the subscriber sets the status of subscriber device 110₁ to “Auto-Lock” (900). This may be accomplished by merely clicking the “Auto-Lock” radio button under the Activate column and confirming that this scenario change event should be communicated to subscriber device 110₁ as illustrated in FIG. 5C. In response to this scenario setting operation, security subnet 120 transmits instructions to subscriber device 110₁ corresponding to the list of recommended actions preconfigured by the subscriber or a newly generated list of actions (910).

The security manager of subscriber device 110₁ detects the instructions and launches the auto-locking agent (920). As a result, the auto-locking agent disables one or more normal accounts, enables the secure auto-lock account, and performs operations on components within subscriber device 110₁ based on the received instructions (930).

After launching the auto-locking agent, subscriber device 110₁ exits the Auto-Lock state only when the current user of subscriber device 110₁ is authenticated as the subscriber or the triggering event has been corrected (undone or reversed).

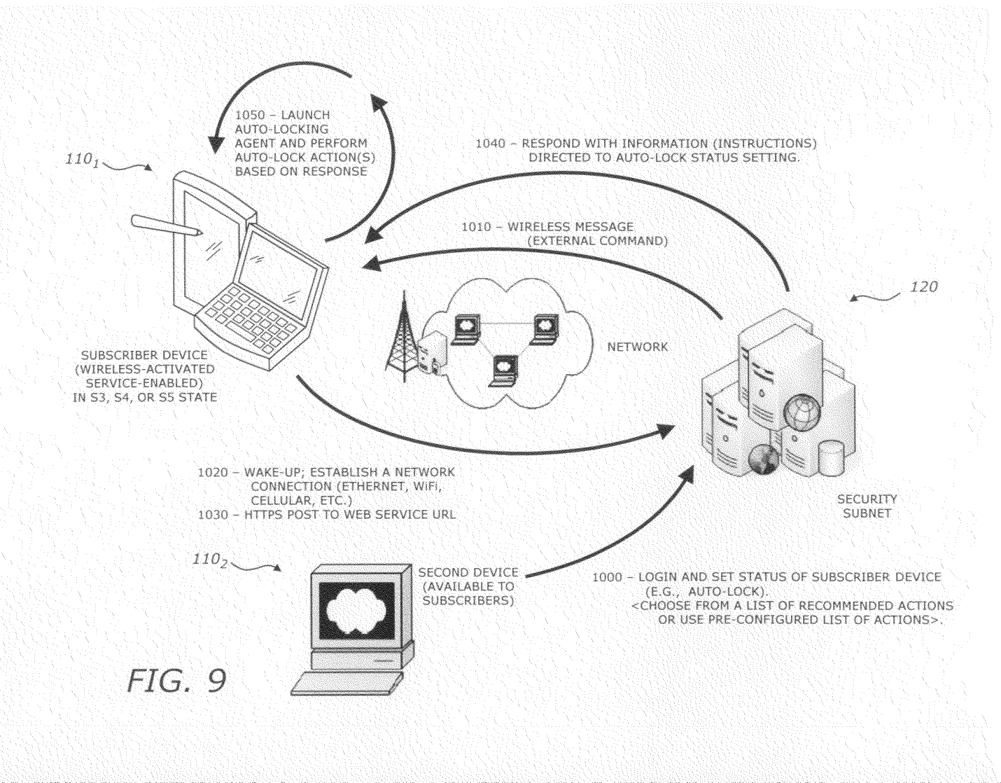

Referring now to FIG. 9, an illustrative embodiment of the operations of subscriber device 110₁ and interactions with the backend server being part of security subnet 120 is shown. Subscriber device 110₁ is in a power-saving state (S3-S5) and is remotely located from the subscriber due to theft for example.

As shown, the subscriber establishes a network connection with security subnet 120 and, since subscriber device 110₁ has been stolen, the subscriber sets the status of the device to “Auto-Lock” (block 1000).

Since there is no network connectivity with the subscriber, security subnet 120 transmits a wireless message (e.g., cellular-based message) to cause subscriber device 110₁ to wake up and establish a network connection with security subnet 120 (blocks 1010, 1020 and 1030). If a network connection cannot be established, this will result in detection of a “local” event, namely receipt of a wireless message and no connectivity to security subnet 120, that will cause subscriber device 110₁ to enter into the Auto-Lock state. However, if network connectivity can be established, security subnet 120 transmits instructions to subscriber device 110₁ in accordance with the selected actions for Auto-Lock (block 1040).

The security manager of subscriber device 110₁ detects the remote event, namely instructions received from by security subnet 120, and launches the auto-locking agent (block 1050). Similarly, according to this embodiment of the invention, the auto-locking agent disables the current accounts (e.g., Windows® accounts), enables the secure auto-lock account, and performs operations on components within subscriber device 110₁ based on based on the type of instructions received.

After launching the auto-locking agent, subscriber device 110₁ exits the Auto-Lock state only when the user is authenticated as the subscriber, which conveys that the subscriber has physical access to subscriber device 110₁, or the triggering event has been corrected (undone or reversed).

In the foregoing description, the invention is described with reference to specific exemplary embodiments thereof. It will, however, be evident that various modifications and changes may be made thereto without departing from the broader spirit and scope of the present invention. Therefore, the specification and drawings are accordingly to be regarded in an illustrative rather than in a restrictive sense.

What is claimed is:

1. Software embodied within machine-readable medium and executed by a processor implemented within an electronic device, the software comprising:
a first module to detect an event; and
a second module in communication with the first module, the second module to perform an activity or series of activities associated with placing the electronic device into a secured operating state.

2. The software of claim 1 wherein the second module placing the electronic device into the secured operating state by disabling access to content stored within the electronic device.

3. The software of claim 1 wherein the second module placing the electronic device into the secured operating state by either (i) disabling components within the electronic device or (ii) displaying a message on a display of the electronic device.

4. The software of claim 1 wherein the first module detecting the event being activation of a kill switch of the electronic device.

5. The software of claim 1 wherein the first module detecting the event being receipt of a request from a remotely located electronic device to place the electronic device into the secured operating state.

6. The software of claim 1 further comprising a third module to authenticate a user of the electronic device, and if the user is authenticated, to place the electronic device into a normal operating state, the second module to perform the activity or the series of activities if the user is not authenticated within a selected period of time.

7. The software of claim 1 wherein the second module placing the electronic device into the secured operating state by enabling a Basic Input/Output System (BIOS) password.

8. The software of claim 1 wherein the second module placing the electronic device into the secured operating state by enabling a hard disk drive (HDD) password.

9. The software of claim 1 wherein the second module placing the electronic device into the secured operating state by resetting a password and performing a full system shutdown of the electronic device after resetting the password.

10. The software of claim 1 wherein the second module placing the electronic device into the secured operating state by activation of global positioning system (GPS) logic.

11. The software of claim 1 wherein the second module placing the electronic device into the secured operating state by activation of a camera mounted on the electronic device.

12. Performed by a subscriber device, a method comprising:
detecting an event that suggests unauthorized access to the subscriber device; and
performing an activity or series of activities in response to detecting the event in order to place the electronic device into a secured operating state.

13. The method of claim 12 wherein the detecting of the event includes receiving a message by the subscriber device to wake up from a Shutdown (S5) state.

14. The method of claim 12 wherein the electronic device is placed into the secured operating state by disabling access to content stored within the electronic device.

15. The method of claim 12 wherein the electronic device is placed into the secured operating state by either (i) disabling components within the electronic device or (ii) displaying a message on a display of the electronic device.

16. The method of claim 12 wherein the detecting of the event includes detecting activation of a kill switch of the electronic device.

17. The method of claim 13 wherein the performing of the activity or the series of activities includes (i) discontinuing a current session by a user and (ii) changing a password setting of the electronic device to a pre-selected password to prevent access to content stored within the electronic device until the user is authenticated.

18. The method of claim 12 further comprising:
detecting whether the event has been undone or reversed, and if so,
allowing the electronic device to remain in a normal operating state or returning the electronic device from the secured operating state to the normal operating state.

19. A subscriber device, comprising:
a processor;
a transceiver communicatively coupled to the processor;
a first component to detect an event that represents unauthorized access of the subscriber device; and
a second component to perform an activity to place the subscriber device into a secured operating state, the activity includes disabling access to content stored within the electronic device.

20. The subscriber device of claim 19 wherein the second component further causes a message to be displayed on a display screen of the subscriber device or causes an audible sound to be output on a speaker of the subscriber device.

21. The subscriber device of claim 19 wherein the second component to further activate global positioning system (GPS) logic within the electronic device.

22. The subscriber device of claim 19 wherein the first component detecting the event upon the transceiver, being powered at all times, receiving a message to wake up the subscriber device from a Shutdown (S5) state.
